(19) United States
(12) Patent Application Publication
(10) Pub. No.: US 2024/0043662 A1
(43) Pub. Date: Feb. 8, 2024

(54) RUBBER COMPOSITION WITH IMPROVED RESISTANCE TO MECHANICAL STRESS

(71) Applicant: COMPAGNIE GENERALE DES ETABLISSEMENTS MICHELIN, Clermont-Ferrand (FR)

(72) Inventors: ROMAIN LIBERT, Clermont-Ferrand (FR); THOMAS FERRAND, Clermont-Ferrand (FR)

(21) Appl. No.: 18/266,360

(22) PCT Filed: Dec. 3, 2021
(86) PCT No.: PCT/FR2021/052201

§ 371 Date: Jun. 9, 2023

(30) Foreign Application Priority Data
Dec. 9, 2020 (FR) 2012882

(51) Int. Cl. C08L 7/00; C08K 3/04; C08K 3/36; B60C 1/00; B60C 11/00; B65G 15/32

(52) U.S. Cl. CPC C08L 7/00; C08K 3/04; C08K 3/36; B60C 1/0016; B60C 11/0008; B65G 15/32; C08L 2205/16; C08L 2312/00; C08L 2205/035; B60C 2011/0025; B62D 55/24

(57) ABSTRACT

A rubber composition exhibiting a good performance compromise between resistance to mechanical attacks and hysteresis, is based on at least one elastomer matrix predominantly comprising at least one isoprene elastomer, a reinforcing filler, cellulose pulp, and a crosslinking system, wherein the cellulose pulp has a length within a range extending from 1.1 to 4.9 mm A rubber article, in particular a pneumatic or non-pneumatic tire for off-road vehicles, a rubber caterpillar track and a conveyor belt comprising the composition are disclosed.

The present invention relates to rubber compositions which exhibit a good performance compromise between the resistance to mechanical attacks and the hysteresis. It relates in particular to rubber articles such as pneumatic tyres, non-pneumatic tyres, caterpillar tracks, conveyor belts or any other rubber article for which the abovementioned performance would be advantageous.

In particular, the rubber compositions of the invention are very advantageous when they are used in treads of pneumatic tyres for civil engineering vehicles. This is because these tyres have to have very different technical characteristics from the tyres intended for vehicles which run exclusively on roads (that is to say a bituminous surface), since the nature of the off-road surfaces on which they are mainly moving is very different and in particular much more aggressive, due to its stony nature. Furthermore, in contrast to passenger vehicle tyres, for example, tyres for large civil engineering vehicles have to be able to withstand a load which can be extremely heavy. Consequently, the solutions known for tyres running on a bituminous surface are not directly applicable to off-road tyres, such as tyres for civil engineering vehicles.

During running, a tread is subjected to mechanical stresses and to attacks resulting from direct contact with the ground. In the case of a tyre fitted to a vehicle bearing heavy loads, the mechanical stresses and the attacks to which the tyre is subjected are magnified under the effect of the weight borne by the tyre. Tyres for mining vehicles in particular are subjected to high stresses, both locally: running over the indenting macrobodies represented by the stones from which the tracks are formed (crushed rock), and also globally: high torque transmission since the slopes of the tracks for entering or leaving the “pits”, or open-air mines, are about 10%, and high stresses on the tyres during U-turns performed by the vehicles for loading and unloading manoeuvres.

The consequence of this is that the incipient cracks which are created in the tyre tread under the effect of these stresses and these attacks have a tendency to further propagate at the surface of or inside the tread, which can bring about localized or generalized tearing of the tread. These stresses can therefore result in damage to the tread and can thus reduce the lifetime of the tread and thus of the tyre. A tyre running over stony ground is highly exposed to attacks, and therefore to incipient cracks and cuts. The actual aggressive nature of the stony ground surface exacerbates not only this type of attack on the tread but also its consequences with regard to the tread.

This is particularly true for the tyres equipping civil engineering vehicles which are moving about generally in mines and quarries. This is also true for the tyres which are fitted to agricultural vehicles, due to the stony ground surface of arable land. The tyres which equip construction site heavy-duty vehicles, which are moving both on stony ground surfaces and on bituminous ground surfaces, also experience these same attacks. Due to the two aggravating factors, which are the weight borne by the tyre and the aggressive nature of the running ground surface, the resistance to crack initiation and/or propagation in a tread of a tyre for a civil engineering vehicle, an agricultural vehicle or a construction site heavy-duty vehicle proves to be crucial in minimizing the impact of the attacks undergone by the tread.

It is thus important to have available tyres for vehicles, in particular those intended to run on stony ground surfaces and bearing heavy loads, the tread of which exhibits a resistance to crack initiation and/or propagation which is sufficiently strong to minimize the number of incipient cracks or the effect of an incipient crack on the lifetime of the tread. In order to solve this problem, it is known to those skilled in the art that, for example, natural rubber in treads makes it possible to obtain elevated properties of resistance to crack initiation and/or propagation.

Furthermore, it remains advantageous for the solutions provided in order to solve this problem not to be disadvantageous to the other properties of the rubber composition, in particular the hysteresis reflecting the heat dissipation capacity of the composition. This is because the use of an excessively hysteretic composition in a tyre may manifest itself in a rise in the internal temperature of the tyre, which may result in a reduction in the durability of the tyre.

In the light of the above, it is an ongoing objective to provide rubber compositions which exhibit an improved compromise between the resistance to attacks and the hysteresis.

This performance compromise is also advantageous for rubber caterpillar tracks intended to be fitted to construction vehicles or agricultural vehicles for the same reasons as set out above. It is also advantageous for conveyor belts (or belt conveyors) which can receive large amounts of earth, ore, stones or rocks and which can dissipate huge amounts of energy via internal dissipation to the material constituting the belt during the crushing of the belt between its load and the support driving it.

Solutions have been provided to improve this compromise. For example, application WO 2016/202970 A1, which proposes using a specific composition, the elastomeric matrix of which comprises a diene elastomer selected from the group consisting of polybutadienes, butadiene copolymers and mixtures thereof, and a styrene thermoplastic elastomer comprising at least one rigid styrene segment and at least one flexible diene segment comprising at least 20% by weight of conjugated diene units.

However, manufacturers are always looking for solutions to further improve the performance compromise between the resistance to attacks and the hysteresis, preferably regardless of the nature of the elastomeric matrix.

Continuing its research, the applicant has unexpectedly discovered that the use of a specific cellulose pulp makes it possible to further improve the abovementioned performance compromise.

Thus, the invention relates to a rubber composition based on at least one elastomer matrix predominantly comprising at least one isoprene elastomer, a reinforcing filler, cellulose pulp, and a crosslinking system, wherein the cellulose pulp has a length within a range extending from 1.1 to 4.9 mm.

It also relates to a rubber article comprising a rubber composition according to the invention, and to a pneumatic or non-pneumatic tyre, a caterpillar track comprising at least one rubber element and a conveyor belt.

### I—Definitions

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The expression “part by weight per hundred parts by weight of elastomer” (or phr) should be understood as meaning, within the meaning of the present invention, the part by mass per hundred parts by mass of elastomer.

In the present document, unless expressly indicated otherwise, all the percentages (%) indicated are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also, and preferentially, denoted.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant elastomer is the elastomer representing the greatest weight relative to the total weight of the elastomers in the composition. In the same way, a “predominant” filler is that representing the greatest weight among the fillers of the composition. By way of example, in a system comprising just one elastomer, the latter is predominant for the purposes of the present invention and, in a system comprising two elastomers, the predominant elastomer represents more than half of the weight of the elastomers. By contrast, a “minor” compound is a compound which does not represent the greatest fraction by weight among the compounds of the same type. Preferably, the term “predominant” is understood to mean present at more than 50%, preferably more than 60%, 70%, 80%, 90%, and more preferentially the “predominant” compound represents 100%.

The compounds mentioned in the description may be of fossil origin or may be biobased. In the latter case, they can result, partially or completely, from biomass or be obtained from renewable raw materials resulting from biomass. In the same way, the compounds mentioned may also originate from the recycling of materials that have already been used, meaning that they may result, partially or completely, from a recycling process, or be obtained from raw materials that themselves result from a recycling process. Polymers, plasticizers, fillers, and the like, are concerned in particular.

All the values for glass transition temperature “Tg” described in the present document are measured in a known manner by DSC (Differential Scanning calorimetry) according to the standard ASTM D3418 (1999).

### II—Description of the Invention

### II-1 Elastomer Matrix

The rubber composition according to the invention has the essential feature of being based on an elastomer matrix predominantly comprising at least one isoprene elastomer. “Isoprene elastomer” is understood to mean, as is known, an isoprene homopolymer or copolymer, in other words a diene elastomer selected from the group consisting of natural rubber (NR), synthetic polyisoprenes (IRs), the various isoprene copolymers and the mixtures of these elastomers. Mention will in particular be made, among the isoprene copolymers, of isobutene/isoprene (butyl rubber—IIR), isoprene/styrene (SIR), isoprene/butadiene (BIR) or isoprene/butadiene/styrene (SB IR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, even more preferentially of greater than 98%.

Advantageously, the isoprene elastomer is a polyisoprene comprising a content by weight of cis-1,4-bonds of at least 90% of the weight of the polyisoprene. Preferably, the second elastomer is selected from the group consisting of natural rubber, synthetic polyisoprenes and mixtures thereof. More preferably, the polyisoprene is a natural rubber.

The isoprene elastomer, preferably natural rubber, may or may not be epoxidized.

Particularly advantageously, the rubber composition comprises from 70 to 100 phr, preferably from 80 to 100 phr, preferably from 90 to 100 phr, of isoprene elastomer, preferably of natural rubber. For example, the rubber composition may comprise from to 99 phr, for example from 80 to 98 phr, for example from 90 to 97 phr, of isoprene elastomer, the balance possibly being another diene elastomer, for example originating from the support of the cellulose pulp.

It should be remembered that “diene elastomer” should be understood as meaning an elastomer which results at least in part (i.e. a homopolymer or a copolymer) from diene monomers (monomers bearing two conjugated or non-conjugated carbon-carbon double bonds).

These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin). The diene elastomers included in the composition are preferentially essentially unsaturated.

Diene elastomer capable of being used in the compositions in accordance with the invention is understood in particular to mean:
(a) any homopolymer of a conjugated or non-conjugated diene monomer containing from 4 to 18 carbon atoms;
b) any copolymer of a conjugated or non-conjugated diene containing from 4 to 18 carbon atoms and of at least one other monomer.

The other monomer can be ethylene, an olefin or a conjugated or non-conjugated diene.

Conjugated dienes that are suitable include conjugated dienes containing from 4 to 12 carbon atoms, in particular 1,3-dienes, in particular such as 1,3-butadiene and isoprene.

Olefins that are suitable include vinylaromatic compounds containing from 8 to 20 carbon atoms and aliphatic α-monoolefins containing from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Aliphatic α-monoolefins that are suitable in particular include acyclic aliphatic α-monoolefins containing from 3 to 18 carbon atoms.

The diene elastomer is preferably a diene elastomer of the highly unsaturated type, in particular a diene elastomer selected from the group consisting of natural rubber (NR), synthetic polyisoprenes (IRs), polybutadienes (BRs), butadiene copolymers, isoprene copolymers and mixtures of these elastomers. Such copolymers are more preferentially selected from the group consisting of butadiene/styrene copolymers (SBRs), isoprene/butadiene copolymers (BIRs), isoprene/styrene copolymers (SIRs), isoprene/butadiene/styrene copolymers (SBIRs), ethylene/butadiene copolymers (EBRs) and mixtures of such copolymers.

The above diene elastomers may be, for example, block, random, sequential or microsequential elastomers and may be prepared in dispersion or in solution; they may be coupled and/or star-branched or else functionalized with a coupling and/or star-branching or functionalization agent, for example epoxidized.

### II-2 Cellulose Pulp

The rubber composition according to the invention also has the essential characteristic of comprising cellulose pulp.

Cellulose pulp is understood to mean cellulose fibres that have undergone a fibrillation step (also called pulping), well known to those skilled in the art. There are many fibrillation processes described in the prior art, and which are mechanical or chemical, described for example in documents WO 83/003856, WO 2013/049222, EP0677122 and EP0494214. Before fibrillation, a fibre, having a length and a given diameter, consists of a plurality of microfibrils that are essentially parallel to one another and are oriented in the direction of the length of the fibre. After fibrillation, certain microfibrils of the fibre have been broken and then emanate from the core of the fibre (and are therefore no longer necessarily oriented in the direction of the length of the fibre).

According to the invention, the cellulose pulp has a length within a range extending from 0.3 to 5 mm. Below 0.3 mm, the contribution of stiffness in the composition becomes too low, while above 5 mm the anisotropy increases strongly, which implies a discrepancy in stiffness depending on the direction of the pulp within the composition.

This discrepancy in stiffness is not advantageous as a result of the purpose of the rubber article comprising the composition: the mechanical attacks undergone by these articles do not come from a single direction but can come from any direction. On the contrary, it is advantageous to have stiffness that does not have a preferential direction. Thus, advantageously, the cellulose pulp has a length within a range extending from 0.5 to 4 mm, preferably from 1.1 to 3.9 mm. The pulp having these lengths has an anisotropy close to the value 1, and therefore a uniform stiffness.

Likewise preferably, the cellulose pulp has a mean diameter within a range extending from 1 to 40 μm, preferably from 3 to 25 μm, preferably from 5 to 15 μm. These diameters, combined with the aforementioned lengths, make it possible to further increase the uniformity of the stiffness, i.e. to have an anisotropy even closer to the value 1.

Particularly advantageously, the cellulose pulp has a length-to-mean diameter ratio within a range extending from 12 to 4000, preferably from 40 to 1300, more preferably from 70 to 600.

The length and mean diameter of the cellulose pulp can easily be measured by light microscope image analysis, scanning electron microscope image analysis, transmission type microscope photograph image analysis, X-ray scattering data analysis.

When the mean diameter of a cellulose pulp is measured, the core diameter constituted by all the microfibrils having retained an orientation in the direction of the main length of the fibre is measured. The mean diameter therefore does not take into account the broken microfibrils emanating from the core of the pulp.

The content of the cellulose pulp in the rubber composition is advantageously within a range extending from 1 to 25 phr, preferably from 3 to 20 phr. Below 1 phr, no effect is observed on the resistance to mechanical attacks, while above 25 phr the composition exhibits limiting properties that are too low.

Preferably, the fibres are coated with an adhesive composition for improving their adhesion to the rubber composition. This adhesive composition may be a conventional resorcinol-formaldehyde-latex adhesive, commonly abbreviated to RFL adhesive, or else an adhesive composition based on a phenol-aldehyde resin and a latex, as described in documents WO 2013/017421, WO 2013/017422, WO 2013/017423, WO 2015/007641 and WO 2015/007642. The use of adhesive compositions based on a phenol-aldehyde resin and a latex is particularly advantageous because no formaldehyde is given off.

Cellulose pulps that can be used in the context of the present invention are commercially available, in particular the “Rhenogran WDP-70/SBR” pulp from the company Lanxess.

### II-3 Reinforcing Filler

The rubber composition according to the invention also comprises a reinforcing filler, known for its abilities to reinforce a rubber composition which can be used for the manufacture of rubber articles.

The reinforcing filler can comprise carbon black, silica, or a mixture thereof. Advantageously, the reinforcing filler predominantly comprises carbon black.

The blacks that can be used in the context of the present invention can be any black conventionally used in pneumatic or non-pneumatic tyres or their treads (“tyre-grade” blacks). Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 or N772 blacks. These carbon blacks can be used in the isolated state, as available commercially, or in any other form, for example as carrier for some of the rubber additives used. The carbon blacks might, for example, be already incorporated in the diene elastomer, in particular isoprene elastomer, in the form of a masterbatch (see, for example, patent applications WO 97/36724 or WO 99/16600).

Mention may be made, as examples of organic fillers other than carbon blacks, of functionalized polyvinyl organic fillers, such as described in applications WO 2006/069792, WO 2006/069793, WO 2008/003434 and WO 2008/003435.

Advantageously, the BET specific surface area of the carbon black is at least 70 m²/g, preferably at least 90 m²/g, more preferably between 100 and 150 m²/g.

The BET specific surface area of the carbon blacks is measured according to the standard ASTM D6556-10 [multipoint (a minimum of 5 points) method—gas: nitrogen—relative pressure p/p₀ range: 0.1 to 0.3].

Advantageously, the content of carbon black in the rubber composition according to the invention is from 10 to 70 phr, preferably from 11 to 65 phr, preferably from 12 to 59 phr.

If silica is used in the rubber composition according to the invention, it can be any silica known to those skilled in the art, in particular any precipitated or fumed silica exhibiting a BET surface area and a CTAB specific surface area which are both less than 450 m²/g, preferably from 30 to 400 m²/g.

The BET specific surface area of the silica is determined by gas adsorption using the Brunauer-Emmett-Teller method described in “The Journal of the American Chemical Society” (Vol. 60, page 309, February 1938), and more specifically according to a method adapted from the standard NF ISO 5794-1, Appendix E of June 2010 [multipoint (5 point) volumetric method—gas: nitrogen—degassing under vacuum: one hour at 160° C.—relative pressure p/p₀ range: 0.05 to 0.17].

The CTAB specific surface area values of the silica were determined according to the standard NF ISO 5794-1, Appendix G of June 2010. The process is based on the adsorption of CTAB (N-hexadecyl-N,N,N-trimethylammonium bromide) on the “external” surface of the reinforcing filler.

If silica is used, it advantageously has a BET specific surface area of less than 200 m²/g and/or a CTAB specific surface area of less than 220 m²/g, preferably a BET specific surface area within a range extending from 125 to 200 m²/g and/or a CTAB specific surface area within a range extending from 140 to 170 m²/g.

Mention will be made, as silicas that can be used in the context of the present invention, for example, of the highly dispersible precipitated silicas (termed “HDSs”) Ultrasil 7000 and Ultrasil 7005 from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

In order to couple the reinforcing silica to the diene elastomer, use may be made, in a well-known way, of an at least bifunctional coupling agent (or bonding agent) intended to provide a satisfactory connection, of chemical and/or physical nature, between the silica (surface of its particles) and the diene elastomer (hereinafter simply referred to as “coupling agent”). Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being able to interact with the hydroxyl groups of an inorganic filler, and a second functional group comprising a sulfur atom, said second functional group being able to interact with the diene elastomer.

Those skilled in the art can find examples of coupling agents in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

However, it is advantageous in the context of the present invention not to use a coupling agent. Thus, preferentially, when silica is used, the content of coupling agent in the rubber composition according to the invention is advantageously less than 6% by weight relative to the weight of silica, preferably less than 2%, preferably less than 1% by weight relative to the weight of silica. More preferably, when silica is used, the rubber composition according to the invention does not comprise coupling agent.

Moreover, when the rubber composition according to the invention comprises silica, the composition advantageously comprises an agent for covering the silica. Among the agents for covering the silica, mention may be made, for example, of hydroxysilanes or hydrolysable silanes such as hydroxysilanes (see, for example, WO 2009/062733), alkylalkoxysilanes, especially alkyltriethoxysilanes such as, for example, 1-octyltriethoxysilane, polyols (for example diols or triols), polyethers (for example polyethylene glycols), primary, secondary or tertiary amines (for example trialkanolamines), an optionally substituted guanidine, especially diphenylguanidine, hydroxylated or hydrolysable polyorganosiloxanes (for example α,ω-dihydroxypolyorganosilanes (especially α,ω-dihydroxypolydimethylsiloxanes) (see, for example, EP 0 784 072), and fatty acids such as, for example, stearic acid. When an agent for covering the silica is used, it is used at a content of between 0 and 5 phr. Preferably, the agent for covering the silica is a polyethylene glycol. When silica is used, the content of agent for covering the silica, preferably of polyethylene glycol, in the rubber composition according to the invention is advantageously within a range extending from 1 to 6 phr, preferably from 1.5 to 4 phr.

Whether or not the composition comprises silica, the total content of reinforcing filler in the rubber composition according to the invention is preferably within a range extending from 10 to 70 phr, preferably between 11 and 65 phr, preferably between 12 and 59 phr.

### II-4 Crosslinking System

The system for crosslinking the rubber composition according to the invention can be based on molecular sulfur and/or on sulfur donors and/or on peroxide, which are well known to those skilled in the art.

The crosslinking system is preferentially a vulcanization system based on sulfur (molecular sulfur and/or sulfur-donating agent).

Whether it comes from molecular sulfur or from the sulfur-donating agent, the sulfur in the rubber composition according to the invention is used at a preferential content of between 0.5 and 10 phr. Advantageously, the sulfur content, in the rubber composition according to the invention, is between 0.5 and 2 phr, preferably between 0.6 and 1.5 phr.

The rubber composition according to the invention advantageously comprises a vulcanization accelerator, which is preferably selected from the group consisting of accelerators of the type of thiazoles and their derivatives, accelerators of the types of sulfenamides and thioureas and of mixtures thereof. Advantageously, the vulcanization accelerator is selected from the group consisting of 2-mercaptobenzothiazyl disulfide (MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), morpholine disulfide, N-morpholino-2-benzothiazolesulfenamide (MBS), dibutylthiourea (DBTU) and of mixtures thereof. Particularly preferably, the primary vulcanization accelerator is N-cyclohexyl-2-benzothiazolesulfenamide (CBS).

The content of vulcanization accelerator in the rubber composition according to the invention is preferentially within a range extending from 0.2 to 10 phr, preferably from 0.5 to 2 phr, preferably between 0.5 and 1.5 phr, more preferably between 0.5 and 1.4 phr.

Advantageously, the sulfur or sulfur donor/vulcanization accelerator weight ratio, in the rubber composition according to the invention, is within a range extending from 1.2 to 2.5, preferably from 1.4 to 2.

### II-5 Possible Additives

The rubber composition according to the invention may optionally also comprise all or some of the usual additives customarily used in elastomer compositions for pneumatic or non-pneumatic tyres, such as for example plasticizers (such as plasticizing oils and/or plasticizing resins), pigments, protective agents such as anti-ozone waxes, chemical anti-ozonants, antioxidants, anti-fatigue agents, reinforcing resins (as described for example in patent application WO 02/10269).

### II-6 Preparation of the Rubber Compositions

The compositions that can be used in the in the context of the present invention can be manufactured in appropriate mixers using two successive preparation phases well known to those skilled in the art:
a first phase of thermomechanical working or kneading (“non-productive” phase), which can be carried out in a single thermomechanical stage during which all the necessary constituents, in particular the elastomeric matrix, the reinforcing filler, the cellulose pulp and the optional other various additives, with the exception of the crosslinking system, are introduced into an appropriate mixer, such as a standard internal mixer (for example of ‘Banbury’ type). The optional filler can be incorporated into the elastomer in one or more portions while thermomechanically kneading. In the case where the filler is already incorporated, in full or in part, in the elastomer in the form of a masterbatch, as is described, for example, in applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in patent applications EP-A-0501227, EP-A-0735088, EP-A-0810258, WO 00/05300 or WO 00/05301.

The final composition thus obtained is then calendered, for example in the form of a sheet or of a slab, in particular for laboratory characterization, or else extruded (or co-extruded with another rubber composition) in the form of a rubber semi-finished product (or profiled element) which can be used in a pneumatic or non-pneumatic tyre, a rubber caterpillar track or a conveyor belt, for example as a tread for a pneumatic or non-pneumatic tyre or as a sidewall for a pneumatic tyre. These products can then be used for the manufacture of pneumatic or non-pneumatic tyres, rubber caterpillar tracks or conveyor belts, according to techniques known to those skilled in the art.

The composition can be either in the raw state (before crosslinking or vulcanization) or in the cured state (after crosslinking or vulcanization).

The crosslinking of the composition can be carried out in a manner known to those skilled in the art, for example at a temperature of between 130° C. and 200° C., under pressure.

### II-7 Rubber Article

The present invention also relates to a rubber article comprising a composition according to the invention.

Taking into account the improved performance compromise in the context of the present invention, the rubber article is advantageously selected from the group consisting of pneumatic tyres for off-road vehicles, non-pneumatic tyres for off-road vehicles, caterpillar tracks and conveyor belts.

More particularly, the invention also relates to a pneumatic or non-pneumatic tyre for off-road vehicles which is provided with a tread comprising a composition according to the invention.

The tread has a tread surface provided with a tread pattern formed by a plurality of grooves delimiting elements in relief (blocks, ribs) so as to generate edge corners of material and also voids. These grooves represent a volume of voids which, relative to the total volume of the tread (including both the volume of elements in relief and that of all the grooves), is expressed by a percentage denoted, in the present document, by “volumetric void ratio”. A volumetric void ratio equal to zero indicates a tread without grooves or voids.

The present invention is particularly well suited to treads of tyres intended to be fitted to civil engineering vehicles, agricultural vehicles and heavy-duty vehicles, more particularly civil engineering vehicles, the tyres of which are subjected to highly specific stresses, in particular the stony ground surfaces on which they run. Thus, advantageously, the pneumatic or non-pneumatic tyre provided with a tread comprising a composition according to the invention is a tyre for a civil engineering vehicle, agricultural vehicle or heavy-duty vehicle, preferably a civil engineering vehicle. These tyres are provided with treads which have, in comparison with the thicknesses of the treads of the tyres for light vehicles, in particular for passenger vehicles or vans, great thicknesses of rubber material. Typically, the wearing part of the tread of a heavy-duty tyre has a thickness of at least 15 mm and that of a civil engineering vehicle is at least 30 mm, indeed even up to 120 mm. Thus, the tread of the tyre according to the invention advantageously has one or more grooves, the mean depth of which ranges from 15 to 120 mm, preferably from 65 to 120 mm.

The pneumatic tyres according to the invention may have a diameter ranging from 20 to 63 inches, preferably from 35 to 63 inches.

Moreover, the mean volumetric void ratio over the whole of the tread of the tyre according to the invention can be within a range extending from 5% to 40%, preferably from 5% to 25%.

The invention also relates to a caterpillar track comprising at least one rubber element comprising a composition according to the invention, the at least one rubber element preferably being an endless rubber belt or a plurality of rubber pads. It also relates to a rubber conveyor belt comprising a composition according to the invention.

The invention relates to the tyres and semi-finished products for tyres described above, and to rubber articles both in the raw state (i.e. before curing) and in the cured state (i.e. after crosslinking or vulcanization).

### III—Preferred Embodiments

In the light of the above, the preferred embodiments of the invention are described below:
1. Rubber composition based on at least one elastomer matrix predominantly comprising at least one isoprene elastomer, a reinforcing filler, cellulose pulp, and a crosslinking system, wherein the cellulose pulp has a length within a range extending from 1.1 to 4.9 mm.
2. Composition according to Embodiment 1, wherein the composition comprises from 70 to 100 phr, preferably from 90 to 100 phr, of isoprene elastomer.
3. Composition according to Embodiment 1 or 2, wherein the at least one isoprene elastomer is selected from the group consisting of natural rubber, synthetic polyisoprenes and mixtures thereof; preferably the isoprene elastomer is a natural rubber.
4. Composition according to any one of the preceding embodiments, wherein the cellulose pulp has a length within a range extending from 1.1 to 3.9 mm, preferably from 1.2 to 2.9 mm.
5. Composition according to any one of the preceding embodiments, wherein the cellulose pulp has a mean diameter within a range extending from 1 to 40 μm, preferably 3 to 25 μm, preferably from 5 to 15 μm.
6. Composition according to any one of the preceding embodiments, wherein the cellulose pulp has a length-to-mean diameter ratio within a range extending from 12 to 4000, preferably from 40 to 1300, more preferably from 70 to 600.
7. Composition according to any one of the preceding embodiments, wherein the content of the cellulose pulp in the composition is within a range extending from 1 to phr, preferably from 3 to 20 phr.
8. Composition according to any one of the preceding embodiments, wherein the cellulose pulp is coated with an adhesive composition.
9. Composition according to Embodiment 8, wherein the adhesive composition is a resorcinol-formaldehyde-latex, termed RFL, adhesive or an adhesive composition based on a phenol-aldehyde resin and a latex.
10. Composition according to any one of the preceding embodiments, wherein the reinforcing filler comprises carbon black, silica or a mixture thereof.
11. Composition according to any one of the preceding embodiments, wherein the reinforcing filler predominantly comprises carbon black.
12. Composition according to Embodiment 10 or 11, wherein the carbon black has a BET specific surface area of at least 90 m²/g, more preferentially between 100 and 150 m²/g.
13. Composition according to any one of the preceding embodiments, wherein the total content of reinforcing filler in the composition is between 10 and 70 phr, preferably between 12 and 59 phr.
14. Rubber article comprising a composition according to any one of Embodiments 1 to 13, said rubber article being selected from the group consisting of pneumatic off-road tyres, non-pneumatic off-road tyres, caterpillar tracks and conveyor belts.
15. Pneumatic or non-pneumatic tyre for off-road vehicles, comprising a composition according to any one of Embodiments 1 to 13, said tyre being a pneumatic tyre, preferably for a civil engineering vehicle or agricultural vehicle, preferably for a civil engineering vehicle.
16. Tyre according to Embodiment 15, the tread of which has one or more grooves, the mean depth of which is within a range extending from 30 to 120 mm, preferably from to 75 mm.
17. Tyre according to Embodiment 15 or 16, having a mean volumetric void ratio over the whole of the tread within a range extending from 5% to 40%, preferably from 5% to 25%.
18. Tyre according to any one of Embodiments 15 to 17, having a diameter within a range extending from 20 to 63 inches, preferably from 35 to 63 inches.
19. Caterpillar track comprising at least one rubber element comprising a composition as defined in any one of Embodiments 1 to 13.
20. Caterpillar track according to Embodiment 19, wherein the at least one rubber element is an endless rubber belt or a plurality of rubber pads.
21. Rubber conveyor belt comprising a composition as defined in any one of Embodiments 1 to 13.

### IV—Examples

### IV-1 Measurements and Tests Used

### Tensile Tests

These tests make it possible to determine the elasticity stresses and the properties at break. Unless otherwise indicated, they are carried out in accordance with French standard NF T 46-002 of September 1988. The “nominal” secant moduli (or apparent stresses, in MPa) at 10% elongation (denoted “MSA10”) are measured in second elongation (i.e., after an accommodation cycle). All these tensile measurements are carried out under the standard conditions of temperature (23±2° C.) and hygrometry (50+5% relative humidity), according to French standard NF T 40-101 (December 1979). The breaking stresses (in MPa) and the elongations at break (in %) are also measured, at a temperature of 23° C.

In order to determine the anisotropy of the composition, the secant moduli were measured on the one hand in the calendering direction (direction C) and on the other hand in the direction perpendicular to the calendering (direction P). The anisotropy criterion is defined as being the MSA10 (direction C)/MSA10 (direction P) ratio. The closer this ratio is to 1, the more uniform is the stiffness of the mixture. In contrast, the further this ratio moves away from 1, the less uniform is the stiffness. For example, a ratio of 5 means that the stiffness in the calendering direction is five times greater than the stiffness in the direction perpendicular to the calendering.

### Dynamic Properties

The dynamic properties G* and max tan(6) are measured on a viscosity analyser (Metravib VA4000) according to the standard ASTM D5992-96. The response of a sample of vulcanized composition (cylindrical test specimen with a thickness of 2 mm and with a cross section of 79 mm²), subjected to a simple alternating sinusoidal shear stress, at a frequency of 10 Hz, is recorded under standard temperature conditions (23° C.) according to Standard ASTM D 1349-09 or at 60° C. A strain amplitude sweep is carried out from 0.1% to 50% (outward cycle) and then from 50% to 0.1% (return cycle). On the return cycle, the value of the loss factor, denoted tan(δ)ₘₐₓ, is recorded.

The hysteresis performance results (tan(δ)max at 60° C.) are expressed as a base 100 percentage relative to the control composition T1. A result greater than 100 indicates an improvement in hysteresis performance, or a decrease in hysteresis.

### Caterpillar Track Test

This test is representative of the resistance to attacks. It consists in running a metal caterpillar track mounted on a pneumatic tyre fitted on a wheel and vehicle, and inflated, on which rubber pads of a given composition are attached, on a track filled with stones, for a certain time. At the end of running, the pads are removed and the number of cuts visible to the naked eye on the surface are counted. The lower the number, the better the attack resistance performance.

To carry out this test, pads of different compositions were manufactured (see Table 1 below) according to the process described in point IV-2 below. To obtain a pad, the non-crosslinked composition obtained in point IV-2 was calendered to a thickness of 5.5 mm, cut out from slabs (2 of 260×120 mm, 2 of 250×100 mm and 2 of 235×90 mm) that are then stacked in a pyramid. This block of 6 slabs was then inserted into a pyramid-shaped mould with a rectangular base of 260×120 mm and a flat top of 235×90 mm in surface area, and cured at a temperature of 120° C. for 300 minutes at a pressure of 180 bar, thus enabling the crosslinking of the composition.

The pads were then mounted on two X-Track10 metal caterpillar tracks from the Caterpillar company, which were themselves mounted on two Michelin Xmine D2 12.00R24 tyres on the rear axle of a Scania R410 truck. The tyres were re-cut to support the caterpillar tracks. The tyres were inflated to a pressure of 7 bar and bore a load of 4250 kg per tyre.

The truck ran on a flat track covered with 30/60 size porphyry stones obtained from Sonvoles Murcia, Spain, for 5 hours at a speed of 5 km/h. The density of stones on the track was around 1000 to 1500 stones per square metre.

At the end of the test, the cuts visible at the surface of the pads were counted. The result was averaged on the basis of 6 pads. The attack performance results are expressed as a base 100 percentage relative to the control composition T1. A result greater than 100 indicates an improvement in the resistance to attacks.

### IV-2 Preparation of the Compositions

In the examples which follow, the rubber compositions were produced as described in point II-6 above. In particular, the “non-productive” phase was carried out in a 0.4 litre mixer for 3.5 minutes, for a mean blade speed of 50 revolutions per minute, until a maximum dropping temperature of 160° C. was reached. The “productive” phase was carried out in an open mill at 23° C. for 5 minutes.

The crosslinking of the composition was carried out at a temperature of between 130° C. and 200° C., under pressure.

### IV-3 Tests on Rubber Compositions

The examples presented below are intended to compare the performance compromise between the resistance to mechanical attacks and the hysteresis of a composition in accordance with the present invention (C1) with two control compositions (T1 and T2), as well as the anisotropy criterion caused by the presence of pulp in the composition.

The compositions tested (in phr, unless indicated otherwise), as well as the results obtained, are presented in Table 1.

TABLE 1

| | T1 | T2 | C1 |
|---|---|---|---|
| Natural rubber | 100 | 87.4 | 95.8 |
| N115(1) | 40 | 40 | 40 |
| Silica(2) | 15 | 15 | 15 |
| TMQ(3) | 1 | 1 | 1 |
| Anti-ozone wax(4) | 1 | 1 | 1 |
| Antioxidant(5) | 1.5 | 1.5 | 1.5 |
| PEG(6) | 2.5 | 2.5 | 2.5 |
| Stearic acid(7) | 1 | 1 | 1 |
| ZnO(8) | 2.5 | 2.5 | 2.5 |
| Aramid pulp(9) | — | 5% by | |
| | | volume | |
| Cellulose pulp(10) | — | | 5% by |
| | | | volume |
| CBS(11) | 1 | 1 | 1 |
| Sulfur | 1.5 | 1.5 | 1.5 |
| Anisotropy criterion | 1 | 5.7 | 1.75 |
| MSA10 (C)/MSA10 (P) | | | |
| Tan(δ)max at 60° C. | 100 | 77 | 100 |
| Resistance to attacks | 100 | 95 | 120 |

(1)Carbon black of N115 grade according to the standard ASTM D-1765
(2)Silica, Zeosil 1165MP from Solvay
(3)2,2,4-Trimethyl-1,2-dihydroquinoline, Pilnox TMQ from Nocil
(4)Varazon 4959 from the Sasol Wax
(5)N-(1,3-Dimethylbutyl)-N-phenyl-para-phenylenediamine, Santoflex 6-PPD from Flexsys
(6)Polyethylene glycol, Carbowax8000 from Dow Corning
(7)Stearic acid, Pristerene 4931 from Uniqema
(8)Zinc oxide of industrial grade from Umicore
(9)Aramid pulp supported at 70% by weight in natural rubber, Rhenogran P91-40/NR from Rhein Chemie - Lanxess, length: 1.5 mm, diameter 10 μm (5% by volume = 21 phr, of which 8.4 phr of aramid pulp and 12.6 phr of natural rubber)
(10)Cellulose pulp supported at 70% by weight in butadiene-styrene copolymer, Rhenogran WPD-70/SBR from Rhein Chemie - Lanxess, length: 1.5 mm, diameter 10 μm (5% by volume = 14 phr of which 9.8 phr of cellulose pulp and 4.2 phr of butadiene-styrene copolymer)
(11)N-Cyclohexyl-2-benzothiazolesulfenamide, Santocure CBS from Flexsys

The results shown in Table 1 above show first of all that the presence of cellulose pulp in accordance with the invention makes it possible to improve the resistance to mechanical attacks without penalizing the hysteresis. In addition, it was observed that the composition in accordance with the invention containing cellulose pulp has an anisotropy of close to 1 and consequently a uniform stiffness compared to a composition comprising aramid pulp.

1.-15. (canceled)

16. A rubber composition based on at least:
one elastomer matrix predominantly comprising at least one isoprene elastomer;
a reinforcing filler;
cellulose pulp; and
a crosslinking system,
wherein the cellulose pulp has a length within a range extending from 1.1 to 4.9 mm.

17. The rubber composition according to claim 16, wherein the rubber composition comprises from 70 to 100 phr of isoprene elastomer.

18. The rubber composition according to claim 16, wherein the at least one isoprene elastomer is selected from the group consisting of natural rubber, synthetic polyisoprenes and mixtures thereof.

19. The rubber composition according to claim 16, wherein the cellulose pulp has a length within a range extending from 1.1 to 3.9 mm.

20. The rubber composition according to claim 16, wherein the cellulose pulp has a mean diameter within a range extending from 1 to 40 μm.

21. The rubber composition according to claim 16, wherein a content of the cellulose pulp is within a range extending from 1 to 25 phr.

22. The rubber composition according to claim 16, wherein the cellulose pulp is coated with an adhesive composition, the adhesive composition being a resorcinol-formaldehyde-latex, termed RFL, adhesive or an adhesive composition based on a phenol-aldehyde resin and a latex.

23. The rubber composition according to claim 16, wherein the reinforcing filler comprises carbon black, silica or a mixture thereof.

24. The rubber composition according to claim 16, wherein the reinforcing filler predominantly comprises carbon black.

25. The rubber composition according to claim 16, wherein a total content of reinforcing filler in the composition is between 10 and 70 phr.

26. A rubber article comprising the rubber composition according to claim 16, the rubber article being selected from the group consisting of pneumatic off-road tires, non-pneumatic off-road tires, caterpillar tracks and conveyor belts.

27. A pneumatic or non-pneumatic tire for off-road vehicles, comprising the rubber composition according to claim 16.

28. A caterpillar track comprising at least one rubber element comprising the rubber composition according to claim 16.

29. The caterpillar track according to claim 28, wherein the at least one rubber element is an endless rubber belt or a plurality of rubber pads.

30. A rubber conveyor belt comprising the rubber composition according to claim 16.
